(19) United States
(12) Patent Application Publication
(10) Pub. No.: US 2023/0199652 A1
(43) Pub. Date: Jun. 22, 2023

(54) SYSTEMS AND METHODS OF POWER MANAGEMENT IN SINGLE RADIO MULTI-LINK DEVICES

(71) Applicant: Meta Platforms Technologies, LLC, Menlo Park, CA (US)

(72) Inventors: Morteza Mehrnoush, Hayward, CA (US); Chunyu Hu, Saratoga, CA (US); Muhammad Kumail Haider, Sunnyvale, CA (US)

(21) Appl. No.: 17/991,278

(22) Filed: Nov. 21, 2022

Related U.S. Application Data
(60) Provisional application No. 63/292,025, filed on Dec. 21, 2021.

(51) Int. Cl. H04W 52/02

(52) U.S. Cl. CPC H04W 52/0229; H04W 52/0216

(57) ABSTRACT

A first wireless multi-link device (MLD) may include a transceiver configured to transmit a first frame to a first station (STA) of a second wireless MLD over a first link of a plurality of links after waiting for an amount of time during which the first STA switches from a listening mode over the first link to a frame exchange mode over the first link. The transceiver may determine whether the first STA is in a power save mode or an active mode, and can transmit, in response to determining that the first STA is in a power save mode, a second frame to a second STA of the second wireless MLD over a second link of the plurality of links without waiting for an amount of time during which the second STA switches from a listening mode over the second link to a frame exchange mode over the second link.

### CROSS-REFERENCE TO RELATED APPLICATION

This application claims priority to U.S. Provisional Patent Application No. 63/292,025 filed on Dec. 21, 2021, which is incorporated by reference herein in its entirety for all purposes.

### FIELD OF DISCLOSURE

The present disclosure is generally related to communications, including but not limited systems and methods of avoiding/bypassing/skipping enhanced multi-link single radio (EMLSR) mode/requirements in order to avoid/reduce overhead.

### BACKGROUND

Artificial reality such as a virtual reality (VR), an augmented reality (AR), or a mixed reality (MR) provides immersive experience to a user. In one example, a user wearing a head wearable display (HWD) can turn the user's head, and an image of a virtual object corresponding to a location of the HWD and a gaze direction of the user can be displayed on the HWD to allow the user to feel as if the user is moving within a space of artificial reality (e.g., a VR space, an AR space, or a MR space). An image of a virtual object may be generated by a console communicatively coupled to the HWD. In some embodiments, the console may have access to a network.

### SUMMARY

Various embodiments disclosed herein are related to a first wireless multi-link device (MLD) may include a transceiver. The transceiver may be configured to transmit a first frame to a first station (STA) of a second wireless MLD over a first link of a plurality of links after waiting for a first amount of time during which the first STA switches from a listening mode over the first link to a frame exchange mode over the first link. The transceiver may be configured to determine whether the first STA is in a power save mode or an active mode. The transceiver may be configured to, in response to determining that the first STA is in a power save mode, transmit a second frame to a second STA of the second wireless MLD over a second link of the plurality of links without waiting for an amount of time during which the second STA switches from a listening mode over the second link to a frame exchange mode over the second link.

In some embodiments, the transceiver may be configured to perform a frame exchange with the second wireless MLD over only one of the plurality of links at any time instance. In some embodiments, the second wireless MLD may include a plurality of STAs each associated with a respective link of the plurality of links, the plurality of STAs including the first STA and the second STA. The transceiver may be configured to determine that each of the plurality of STAs except the second STA is in a power save mode. The transceiver may be configured to transmit a third frame to the second STA over the second link without waiting for an amount of time during which the second STA switches from the listening mode over the second link to the frame exchange mode over the second link.

In some embodiments, before transmitting the first frame, the transceiver may be configured to generate a fourth frame including a first trigger frame and a padding portion corresponding to the first amount of time, and transmit the first frame to the first STA. The first trigger frame may include one of a multi-user request to send (MU-RTS) frame or a buffer status report poll (BSRP) frame.

In some embodiments, after transmitting the first frame, the transceiver may be configured to receive a fifth frame from the first STA after waiting for a second amount of time during which the first STA performs a transition from the listening mode over the first link to the frame exchange mode over the first link. The transceiver may be configured to determine, according to a medium access control (MAC) header of the fifth frame, whether the first STA is in a power save mode or an active mode.

In some embodiments, in response to determining that the first STA is in a power save mode and in an awake state, the transceiver may be configured to receive a second trigger frame from the first STA. In response to the second trigger, the transceiver may be configured to generate a sixth frame including a sixth trigger frame and a padding portion corresponding to the first amount of time, and transmit the sixth frame to the first STA. The second trigger frame may be one of a power save poll (PS-Poll) frame or an unscheduled automatic power save delivery (U-APSD) trigger frame. The sixth trigger frame may include one of a multi-user request to send (MU-RTS) frame or a buffer status report poll (BSRP) frame.

In some embodiments, the transceiver may be configured to perform, after waiting for the first amount of time, a frame exchange with the first STA. The transceiver may be configured to wait, upon completion of a frame exchange, for an amount of time during which the first STA and the second STA switch to the listening mode.

In some embodiments, in response to determining that the first STA is in the power save mode and in a doze state, the transceiver may be configured to start a first frame exchange with the second STA over the second link. Upon completion of the first frame exchange, the transceiver may be configured to start a second frame exchange with the second STA without waiting for an amount of time during which the first STA and the second STA switch to the listening mode.

Various embodiments disclosed herein are related to a method including transmitting, by a first wireless multi-link device (MLD), a first frame to a first station (STA) of a second wireless MLD over a first link of a plurality of links after waiting for a first amount of time during which the first STA switches from a listening mode over the first link to a frame exchange mode over the first link. The method may include determining, by the first wireless MLD, whether the first STA is in a power save mode or an active mode. The method may include in response to determining that the first STA is in a power save mode, transmitting, by the first wireless MLD, a second frame to a second STA of the second wireless MLD over a second link of the plurality of links without waiting for an amount of time during which the second STA switches from a listening mode over the second link to a frame exchange mode over the second link.

In some embodiments, the first wireless MLD may perform a frame exchange with the second wireless MLD over only one of the plurality of links at any time instance. In some embodiments, the second wireless MLD may include a plurality of STAs each associated with a respective link of the plurality of links, the plurality of STAs including the first STA and the second STA. The first wireless MLD may determine that each of the plurality of STAs except the second STA is in a power save mode. The first wireless MLD may transmit a third frame to the second STA over the second link without waiting for an amount of time during which the second STA switches from the listening mode over the second link to the frame exchange mode over the second link.

In some embodiments, before transmitting the first frame, the first wireless MLD may generate a fourth frame including a first trigger frame and a padding portion corresponding to the first amount of time, and transmit the first frame to the first STA. The first trigger frame may include one of a multi-user request to send (MU-RTS) frame or a buffer status report poll (BSRP) frame.

In some embodiments, after transmitting the first frame, the first wireless MLD may receive a fifth frame from the first STA after waiting for a second amount of time during which the first STA performs a transition from the listening mode over the first link to the frame exchange mode over the first link. The first wireless MLD may determine, according to a medium access control (MAC) header of the fifth frame, whether the first STA is in a power save mode or an active mode.

In some embodiments, in response to determining that the first STA is in a power save mode and in an awake state, the first wireless MLD may receive a second trigger frame from the first STA. In response to the second trigger, the first wireless MLD may generate a sixth frame including a sixth trigger frame and a padding portion corresponding to the first amount of time, and transmit the sixth frame to the first STA. The second trigger frame may be one of a power save poll (PS-Poll) frame or an unscheduled automatic power save delivery (U-APSD) trigger frame. The sixth trigger frame may include one of a multi-user request to send (MU-RTS) frame or a buffer status report poll (BSRP) frame.

In some embodiments, the first wireless MLD may perform, after waiting for the first amount of time, a frame exchange with the first STA. The first wireless MLD may wait, upon completion of a frame exchange, for an amount of time during which the first STA and the second STA switch to the listening mode.

In some embodiments, in response to determining that the first STA is in the power save mode and in a doze state, the first wireless MLD may start a first frame exchange with the second STA over the second link. Upon completion of the first frame exchange, the first wireless MLD may start a second frame exchange with the second STA without waiting for an amount of time during which the first STA and the second STA switch to the listening mode.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4A illustrates an example block diagram of a system environment including one or more wireless multi-link devices (MLDs) in an enhanced multi-link single radio (EMLSR) mode, according to an example implementation of the present disclosure.

FIG. 4B illustrates an example frame sequence in communicating with a wireless MLD in an EMLSR mode, according to an example implementation of the present disclosure.

FIG. 5 illustrates an example frame sequence in communicating with a single station (STA), according to an example implementation of the present disclosure.

FIG. 6 illustrates an example block diagram of a system environment including one or more wireless multi-link devices (MLDs), according to an example implementation of the present disclosure.

FIG. 7A and FIG. 7B illustrate an example frame sequence in communicating with a wireless MLD, according to an example implementation of the present disclosure.

FIG. 8 is a flowchart showing a process of communicating with a wireless MLD, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

One example implementation relates to avoiding/bypassing/skipping enhanced multi-link single radio (EMLSR) mode in order to avoid/reduce overhead associated with the EMLSR mode, for a non-AP multi-link device (MLD) that switches between its power management modes while managing potential wireless communications with an AP MLD. Because such overhead may incur an unnecessary and significant delay for a STA in a non-AP MLD to access the medium in a link, this can increase latency in communications between the two devices. More importantly, such overhead may degrade the medium utilization and efficiency of the network which is important in congested environments. Low latency operations can be important in some applications, such as AR/VR application. An example implementation/solution can involve that, when a first STA of the non-AP MLD switches to a power-save mode and enters a doze/sleep state, a second STA of the non-AP MLD can remain in awake state with which the AP MLD can perform frame exchange without the EMLSR frame exchange procedure. Instead, the AP MLD can perform frame exchange with the second STA using a procedure corresponding to a single-STA frame sequence, which can avoid some or all overhead associated with the EMLSR frame exchange procedure.

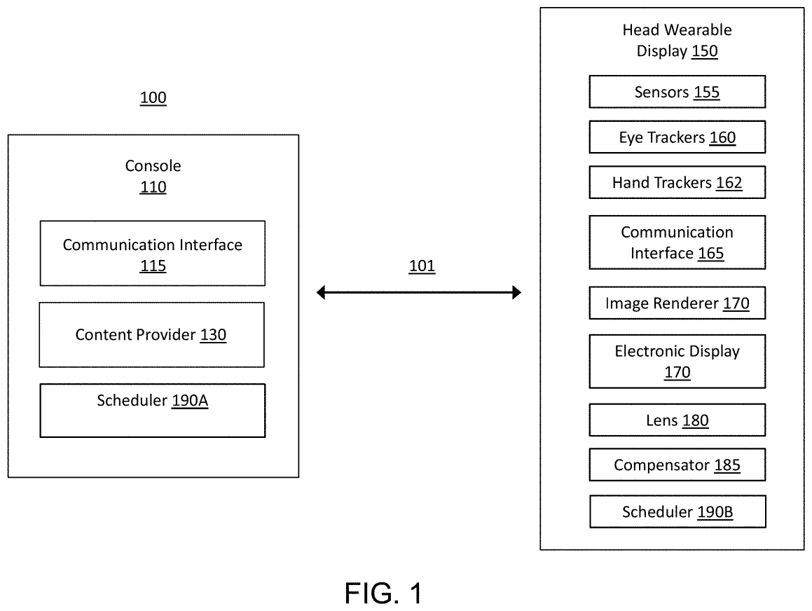

FIG. 1 is a block diagram of an example artificial reality system environment 100 in which a console 110 operates. FIG. 1 provides an example environment in which devices may communicate traffic streams with different latency sensitivities/requirements. In some embodiments, the artificial reality system environment 100 includes a HWD 150 worn by a user, and a console 110 providing content of artificial reality to the HWD 150. A head wearable display (HWD) may be referred to as, include, or be part of a head mounted display (HMD), head mounted device (HMD), head wearable device (HWD), head worn display (HWD) or head worn device (HWD). In one aspect, the HWD 150 may include various sensors to detect a location, an orientation, and/or a gaze direction of the user wearing the HWD 150, and provide the detected location, orientation and/or gaze direction to the console 110 through a wired or wireless connection. The HWD 150 may also identify objects (e.g., body, hand face).

The console 110 may determine a view within the space of the artificial reality corresponding to the detected location, orientation and/or the gaze direction, and generate an image depicting the determined view. The console 110 may also receive one or more user inputs and modify the image according to the user inputs. The console 110 may provide the image to the HWD 150 for rendering. The image of the space of the artificial reality corresponding to the user's view can be presented to the user. In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the console 110 may be performed by the HWD 150, and/or some of the functionality of the HWD 150 may be performed by the console 110.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the console 110, or both, and presents audio based on the audio information. In some embodiments, the HWD 150 includes sensors 155, eye trackers 160, a communication interface 165, an image renderer 170, an electronic display 175, a lens 180, and a compensator 185. These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the eye trackers 160 include electronic components or a combination of electronic components and software components that determine a gaze direction of the user of the HWD 150. In some embodiments, the HWD 150, the console 110 or a combination may incorporate the gaze direction of the user of the HWD 150 to generate image data for artificial reality. In some embodiments, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers 160 incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers 160 may determine that the gaze direction of the user is 20 degrees from the reference direction. In some embodiments, a user of the HWD 150 can configure the HWD 150 (e.g., via user settings) to enable or disable the eye trackers 160. In some embodiments, a user of the HWD 150 is prompted to enable or disable the eye trackers 160.

In some embodiments, the hand tracker 162 includes an electronic component or a combination of an electronic component and a software component that tracks a hand of the user. In some embodiments, the hand tracker 162 includes or is coupled to an imaging sensor (e.g., camera) and an image processor that can detect a shape, a location and/or an orientation of the hand. The hand tracker 162 may generate hand tracking measurements indicating the detected shape, location and/or orientation of the hand.

In some embodiments, the communication interface 165 includes an electronic component or a combination of an electronic component and a software component that communicates with the console 110. The communication interface 165 may communicate with a communication interface 115 of the console 110 through a communication link. The communication link may be a wireless link, a wired link, or both. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the console 110 and the head wearable display 150 are implemented on a single system, the communication interface 165 may communicate with the console 110 through a bus connection or a conductive trace. Through the communication link, the communication interface 165 may transmit to the console 110 sensor measurements indicating the determined location of the HWD 150, orientation of the HWD 150, the determined gaze direction of the user, and/or hand tracking measurements. Moreover, through the communication link, the communication interface 165 may receive from the console 110 sensor measurements indicating or corresponding to an image to be rendered.

Using the communication interface, the console 110 (or HWD 150) may coordinate operations on link 101 to reduce collisions or interferences. For example, the console 110 may coordinate communication between the console 110 and the HWD 150. In some implementations, the console 110 may transmit a beacon frame periodically to announce/advertise a presence of a wireless link between the console 110 and the HWD 150 (or between two HWDs). In an implementation, the HWD 150 may monitor for or receive the beacon frame from the console 110, and can schedule communication with the HWD 150 (e.g., using the information in the beacon frame, such as an offset value) to avoid collision or interference with communication between the console 110 and/or HWD 150 and other devices.

The console 110 and HWD 150 may communicate using link 101 (e.g., intralink). Data (e.g., a traffic stream) may flow in a direction on link 101. For example, the console 110 may communicate using a downlink (DL) communication to the HWD 150 and the HWD 150 may communicate using an uplink (UL) communication to the console 110.

In some embodiments, the image renderer 170 includes an electronic component or a combination of an electronic component and a software component that generates one or more images for display, for example, according to a change in view of the space of the artificial reality. In some embodiments, the image renderer 170 is implemented as a processor (or a graphical processing unit (GPU)) that executes instructions to perform various functions described herein. The image renderer 170 may receive, through the communication interface 165, data describing an image to be rendered, and render the image through the electronic display 175. In some embodiments, the data from the console 110 may be encoded, and the image renderer 170 may decode the data to generate and render the image. In one aspect, the image renderer 170 receives the encoded image from the console 110, and decodes the encoded image, such that a communication bandwidth between the console 110 and the HWD 150 can be reduced.

In some embodiments, the image renderer 170 receives, from the console, 110 additional data including object information indicating virtual objects in the artificial reality space and depth information indicating depth (or distances from the HWD 150) of the virtual objects. Accordingly, the image renderer 170 may receive from the console 110 object information and/or depth information. The image renderer 170 may also receive updated sensor measurements from the sensors 155. The process of detecting, by the HWD 150, the location and the orientation of the HWD 150 and/or the gaze direction of the user wearing the HWD 150, and generating and transmitting, by the console 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer 170 may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer 170 may generate a small portion (e.g., 10%) of an image corresponding to an updated view within the artificial reality according to the updated sensor measurements, and append the portion to the image in the image data from the console 110 through reprojection. The image renderer 170 may perform shading and/or blending on the appended edges. Hence, without recreating the image of the artificial reality according to the updated sensor measurements, the image renderer 170 can generate the image of the artificial reality.

In other implementations, the image renderer 170 generates one or more images through a shading process and a reprojection process when an image from the console 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some embodiments, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some embodiments, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some embodiments, the console 110 is an electronic component or a combination of an electronic component and a software component that provides content to be rendered to the HWD 150. In one aspect, the console 110 includes a communication interface 115 and a content provider 130. These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view. In other embodiments, the console 110 includes more, fewer, or different components than shown in FIG. 1. In some embodiments, the console 110 is integrated as part of the HWD 150. In some embodiments, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link (e.g., USB cable, a wireless link). Through the communication link, the communication interface 115 may receive from the HWD 150 sensor measurements indicating the determined location and/or orientation of the HWD 150, the determined gaze direction of the user, and/or hand tracking measurements. Moreover, through the communication link, the communication interface 115 may transmit to the HWD 150 data describing an image to be rendered.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space.

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

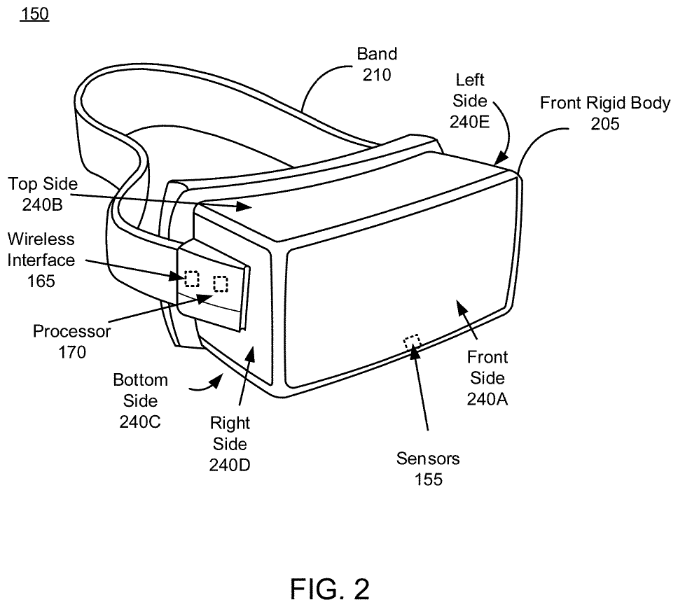

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the embodiment shown by FIG. 2, the sensors 155 are located within the front rigid body 205, and may not visible to the user. In other embodiments, the HWD 150 has a different configuration than shown in FIG. 2. For example, the image renderer 170, the eye trackers 160A, 160B, and/or the sensors 155 may be in different locations than shown in FIG. 2.

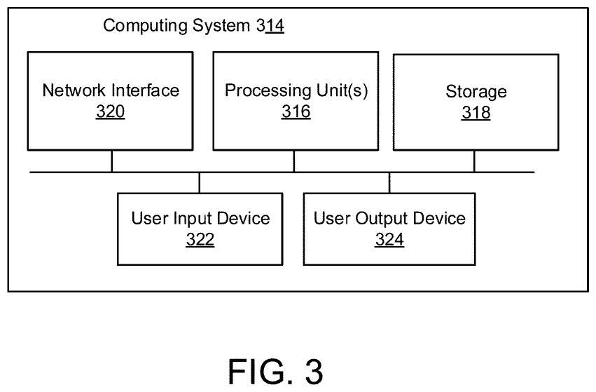

Various operations described herein can be implemented on computer systems. FIG. 3 shows a block diagram of a representative computing system 314 usable to implement the present disclosure. In some embodiments, the console 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

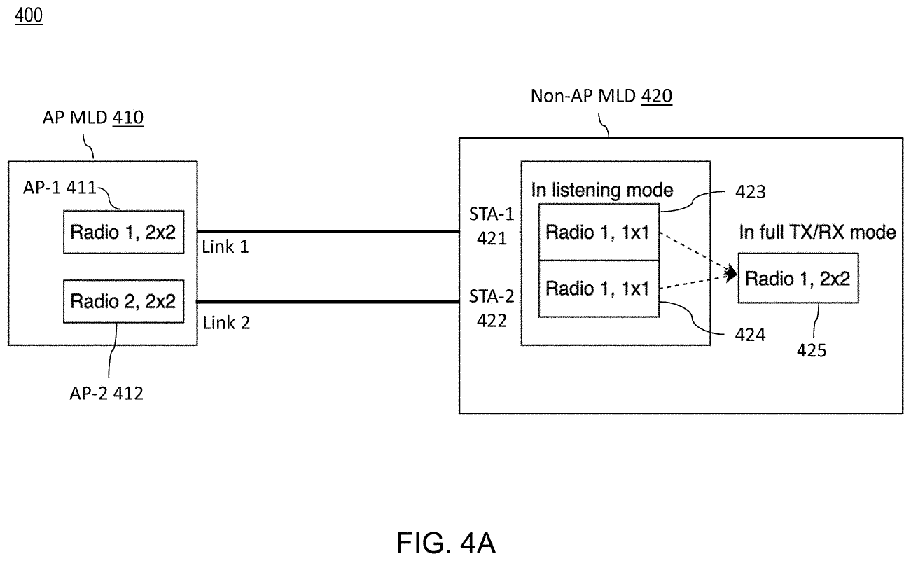

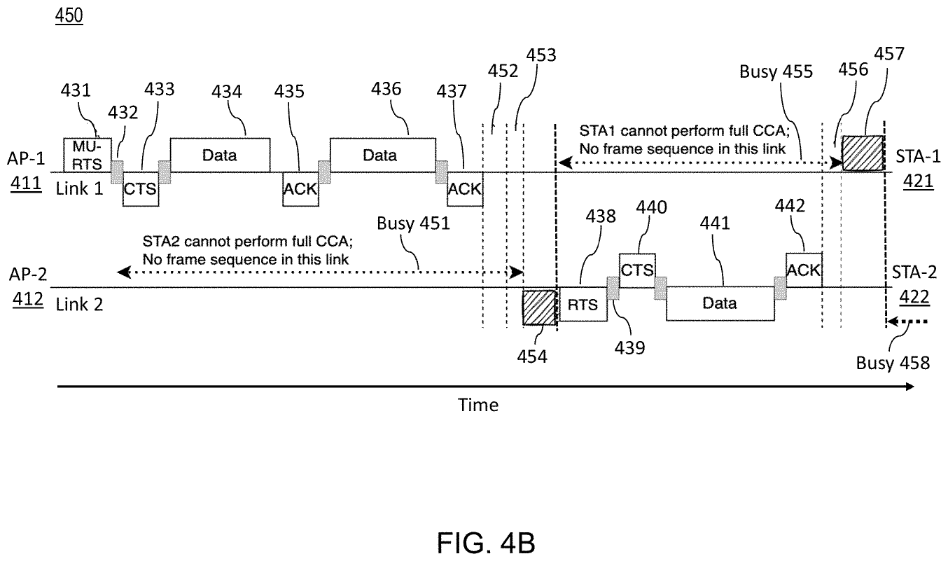

FIG. 4A illustrates an example block diagram a of a system environment 400 including one or more wireless multi-link devices (MLDs) in an enhanced multi-link single radio (EMLSR) mode, according to an example implementation of the present disclosure. An AP MLD 410 may include a first radio 411 (e.g., first radio transceiver; “radio 1” or “AP-1” in FIG. 4A) and a second radio 412 (e.g., second radio transceiver; “radio 2” or “AP-2” in FIG. 4A) each of which may be a 2×2 radio (e.g., 2×2 multiple-input multiple-output (MIMO) radio) configured to communicate via two streams of transmit (TX) and receive (RX) over respective links (e.g., link 1 and link 2). The AP MLD 410 may have full simultaneous TX/RX (STR) capability.

A non-AP MLD 420 may comprise a first station STA-1 (421) and a second station STA-2 (422), which shares a single radio or an enhanced single radio (e.g., single radio transceiver; “radio 1” in FIG. 4A) that operates in an EMLSR mode over a subset of links associated with the AP MLD 410. The single radio of the non-AP MLD 420 may monitor channel status (CCA) over a subset of links (e.g., link 1, link 2) in a listening mode. In the listening mode, the single radio of the non-AP MLD 420 may function as a 1×1 radio 423 (as STA-1) over link 1, or as a 1×1 radio 424 (as STA-2) over link 2. At any time instance, the single radio of the non-AP MLD 420 can participate in a frame exchange (e.g., delivering a data frame) only over one link (e.g., functioning as STA-1 over link 1 or as STA-2 over link 2) in a frame exchange mode or a full TX/RX mode. In the frame exchange mode, the single radio of the non-AP MLD 420 may function as a 2×2 radio 424 configured to communicate via two streams of TX and RX over any link of the subset of links (e.g., over link 1 or over link 2).

FIG. 4B illustrates an example frame sequence 450 in communicating with a wireless MLD in an EMLSR mode, according to an example implementation of the present disclosure. With the configuration of the AP MLD 410 and the non-AP MLD 420 as shown in FIG. 1, AP-1 411 of the AP MLD 410 may exchange a sequence of frames (e.g., a multi-user request-to-send (MU-RTS) frame 431, a clear-to-send (CTS) frame 433, a downlink (DL) data frame 434, and an acknowledgement (ACK) frame 435, a DL data frame 436, an ACK frame 437) with the STA-1 of the non-AP MLD 420 (in a frame exchange mode) over link 1, while the link 2 is in a busy or blind state during a busy/blind period 451. Before switching to the frame exchange mode, both STA-1 and STA-2 of the non-AP MLD may be in a listening mode and then configure the radio (e.g., single radio transceiver; “radio 1” in FIG. 4A) such that the radio switches to only one link (e.g., link 1) for the frame exchange. During the frame exchange over link 1, there is a pre-defined amount of time (e.g., short inter-frame Space (SIFS) 432) between one frame and the next frame transmitted in response to the one frame (e.g., MU-RTS frame 431 and CTS frame 433). During the busy/blind period 451, STA-2 of the non-AP MLD 420 cannot perform a full CCA over link 2 such that no frame sequence can occur in link 2 because all the radios of the non-AP MLD are operating on link 1 and there is no radio for frame exchange on link 2.

After waiting for an amount of time or switching delay (e.g., amount of time 452 and/or 453), STA-1 and STA-2 of the non-AP MLD 420 may switch to a listening mode from the frame exchange mode. After the STA-1 of the non-AP MLD finishes/completes the frame exchange over link 1 in the frame exchange mode, the non-AP MLD may reconfigure the radio (e.g., single radio transceiver; “radio 1” in FIG. 4A), and both STA-1 and STA-2 of the non-AP MLD may switch (or switch/go back) to the listening mode. The amount of time may include at least one of an amount of time 452 for occupying a wireless medium (e.g., Point coordination function inter-frame Space (PIFS) and RxPHYStartDelay) and/or an amount of time 453 for link transition (e.g., EMLSR transition delay 453). After switching to the listening mode, STA-2 of the non-AP MLD 420 may perform/conduct a medium synchronization recovery procedure 454 to start a medium contention over a corresponding link (e.g., link 2) over which STA-2 has not performed TX/RX on. Subsequently, STA-2 of the non-AP MLD 420 may exchange a sequence of frames (e.g., an RTS frame 438, a CTS frame 440, a UL data frame 441, and an ACK frame 442) with AP-2 412 of the AP MLD 410 (in a frame exchange mode) over link 2, while the link 1 is in a busy/blind state during a busy/blind period 455. During the frame exchange over link 2, there may be a pre-defined amount of time (e.g., SIFS 439) between one frame and the next frame transmitted in response to the one frame (e.g., RTS frame 438 and CTS frame 440). During the busy/blind period 455, STA-1 of the non-AP MLD 420 cannot perform a full CCA over link 1 such that no frame sequence can occur in link 1. After waiting for an amount of time 456 for link transition (e.g., EMLSR transition delay 456), STA-1 and STA-2 of the non-AP MLD 420 may switch to a listening mode and then the link 2 may switch to a busy/blind state during a busy/blind period 458, during which STA-2 of the non-AP MLD 420 cannot perform a full CCA over link 2 such that no frame sequence can occur in link 2. After switching to the listening mode, STA-1 of the non-AP MLD 420 may perform/conduct a medium synchronization recovery procedure 457.

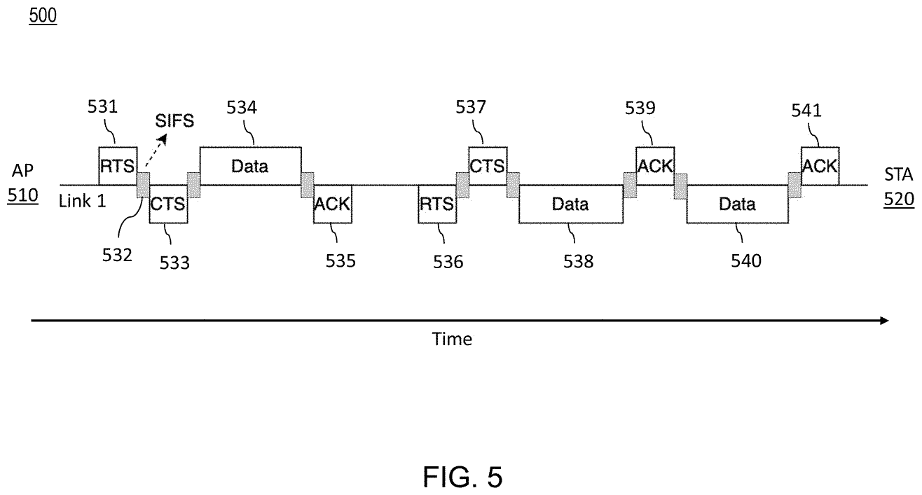

FIG. 5 illustrates an example frame sequence 500 in communicating with a single station (STA), according to an example implementation of the present disclosure. Referring to FIG. 5, an AP (AP 510) may exchange a sequence of frames (e.g., an RTS frame 531, a CTS frame 533, a DL data frame 534, an ACK frame 535, an RTS frame 536, a CTS frame 537, an uplink (UL) data frame 538, an ACK frame 539, an UL data 540, and/or an ACK frame 541) with a station (non-AP STA 520) (in a frame exchange mode) over a single link (link 1).

Compared to the EMLSR frame sequence 450 in FIG. 4B, in the frame sequence 500 in FIG. 5, the non-AP STA 520 may not wait (e.g., can avoid waiting) for an amount of time or switching delay (e.g., amount of time 452, 453, 455 in the frame sequence 450 in FIG. 4B) during the frame exchange with the AP 510 and may not perform/conduct (e.g., can avoid performing/conducting) a medium sync recovery procedure to start a medium contention over link 1. For example, the switching delay (e.g., PIFS/RxPHYStartDelay 452 and/or EMLSR transition delay 453) in the enhanced single radio in the non-AP MLD 420 may take a non-negligible time (e.g., several hundred μs) to switch between the listening mode and the frame exchange mode (or full TX/RX mode).

Moreover, the enhanced single radio of the non-AP MLD 420 (see FIG. 4A) may incur several overheads when operating in the EMLSR mode. For example, during the time the enhanced single radio conducts TX/RX (in the frame exchange mode) on one link, the radio may be “blind” in other links (e.g., busy/blind period 451, 455, 458). When a STA of the AP MLD 410 (e.g., AP-1 or AP-2) initiates one or multiple frame exchanges, the first frame exchange may start with a trigger frame exchange (e.g., MU-RTS 431 or buffer status report poll (BSRP)) followed by a response frame (e.g., CTS frame 433 or buffer status report (BSR) frame). The MU-RTS trigger frame or BSRP trigger frame may have padding (e.g., padding bits) that is sufficient to cover a switching time of the single radio (e.g., STA-1 or STA-2 of non-AP MLD). For example, an amount of time or delay corresponding to the padding may be several hundred μs. In contrast, in the frame sequence 500 for a single STA, a frame exchange of RTS/CTS can be optional and can be skipped, thus not contributing to overhead. The non-AP MLD 420 may determine that frame exchanges have ended for a corresponding STA (e.g., STA-1 or STA-2) before switching to the listening mode, and can use a time-out period (or switching delay) combined with a few events check conditions (during PIFS/RXPhyStartDelay 452 or 456) for the EMLSR non-AP MLD to determine if the corresponding STA can safely switch back to the listening mode. The time-out period may take several hundreds μs. After switching to the listening mode, STA 1 and STA 2 of the EMLSR non-AP MLD may conduct a medium synchronization recovery procedure (e.g., medium synchronization recovery 454, 457) to start medium contention over the links on which the STA has not TX/RX. For example, the medium synchronization recovery procedure 454 may allow STA-2 which has not been listening on (thus unaware of status/activity of) link 2, to determine if STA-2 can start to perform medium contention on link 2. As described above, the communication between an AP MLD and an EMLSR non-AP MLD may endure/incur significant overhead even when the non-AP MLD practically operates over only one link at a time.

To solve these problems, according to certain aspects, embodiments in the present disclosure relate to techniques for removing/reducing/avoiding/saving such overhead incurred by an EMLSR non-AP MLD when the non-AP MLD practically operates over only one link at a time. For example, an EMLSR non-AP MLD device in communication with an AP MLD over a plurality of links can change a power management mode to a power save mode in all the links associated with the AP MLD, except one link that stays in an active mode. In this case, only one STA of the non-AP MLD can be in the awake state or in the active mode, and the non-AP MLD practically operates over only one link at a time. Therefore, the one STA can operate like a single STA device and can potentially use a frame sequence for a single STA (e.g., the frame sequence 500 in FIG. 5). Another example is that when all the links except one link between the AP MLD and the non-AP MLD are removed or disabled, the AP MLD and the STA of the non-AP MLD can follow a single link operation (e.g., the operation shown in FIG. 5) instead of EMLSR operation (e.g., the operation shown in FIG. 4B).

In one approach, an EMLSR MLD device (e.g., EMLSR non-AP MLD) may change or set the power management mode to a power save mode over all the associated links except one link. In this case, all the STAs of the non-AP MLD may be in the power save mode in which the corresponding STA can be in an awake state or in a doze state, except for the STA corresponding to the one link can stay in the active mode in which the STA corresponding to the one link is in an awake state, and thus the non-AP MLD practically operates over only one link at a time like a single STA. In a case in which an EMLSR non-AP MLD changes or sets the power management mode to a power save mode over all the associated links except one link (“single STA link”), when an AP MLD initiates a frame exchange over the single STA link for DL transmission, the AP MLD may follow or perform a frame exchange procedure as if the non-AP MLD were a single radio STA. For example, when the AP MLD initiates a frame exchange over the single STA link for DL transmission, the AP MLD may use a single STA frame sequence (e.g., the frame sequence shown in FIG. 5) without incurring the overhead(s) of EMLSR (e.g., padding, switching delay, and/or medium synchronization recovery). In some embodiments, for the single STA link, the AP MLD may not use a frame sequence of a trigger frame (e.g., MU-RTS or BSRP) and a corresponding response frame to proceed the DL transmission. In some embodiments, for the single STA link, the AP MLD may use the frame sequence of a trigger frame and a corresponding response frame but may not add the padding to the trigger frame.

In one approach, the AP MLD may operate on the single STA link, assuming that the EMLSR non-AP MLD can perform in full TX/RX capability over the single STA link. For example, the AP MLD may determine a timing of initiating a frame exchange over the single STA link without considering a switching delay between the listening mode and the full TX/RX mode over the single STA link, and/or without considering an amount of time for a medium synchronization recovery.

In one approach, the AP MLD may initiate a frame exchange for a DL transmission over a link (“EMLSR link”) over which the non-AP MLD is in a power save mode and in an awake state. When the AP MLD initiates a frame exchange for a DL transmission over the EMLSR link, upon receiving a power save poll (PS-Poll) frame or an unscheduled automatic power save delivery (U-APSD) trigger frame over the EMLSR link, the AP MLD may follow or perform an EMLSR frame exchange procedure that may incur the overhead (e.g., padding, switching delay, and/or medium synchronization recovery, as shown in FIG. 4B), over the EMLSR link.

In one approach, the AP MLD may determine that the non-AP MLD intends to (or is to) perform UL transmission over a link (“EMLSR link”) over which the non-AP MLD is in a power save mode and in an awake state. Upon determination of the non-AP MLD's intention for UL transmission over the EMLSR link, the AP MLD may follow or perform an EMLSR frame exchange procedure for the DL transmission.

In one approach, a first station (STA-1) of the non-AP MLD which includes the first station and a second station (STA-2) may switch to a power save mode and a doze state over a first link (“first EMLSR link”). In some embodiments, STA-1 may send, to a corresponding STA of the AP MLD (e.g., AP-1), a frame with a power management (PM) subfield (or PM bit) in a MAC header of the frame (e.g., frame control field) being set to 1, to indicate that STA-1 is switching to a power save mode (and a doze state). After receiving an ACK frame from AP-1, STA-1 may start a power save mode and switch into the doze state.

In one approach, when STA-1 of the non-AP MLD switches to the power save mode and the doze state over the first EMLSR link, only STA-2 (among STA-1 and STA-2) may remain in an active mode and in an awake state over a second link (“second single STA link”). The AP MLD can then perform a frame exchange with STA-2 over the second single STA link as a single STA frame exchange without performing an EMLSR frame exchange procedure that may incur the overhead, over the second single STA link. In some embodiments, when STA-1 switches to an awake state over the first EMLSR link, upon receiving a trigger frame (e.g., PS-Poll or U-APSD frame), the AP MLD can perform or follow the EMLSR operation (e.g., frame exchange operation).

In one approach, a first wireless multi-link device (e.g., AP MLD) may include a transceiver (e.g., a pair of 2×2 radio transceivers). The transceiver may transmit a first frame (e.g., data frame) to a first station (e.g., STA-1) of a second wireless MLD (e.g., EMLSR non-AP MLD) over a first link of a plurality of links after waiting for a first amount of time (e.g., EMLSR padding delay) during which the first STA switches from a listening mode over the first link to a frame exchange mode over the first link. The transceiver may determine whether the first STA is in a power save mode or an active mode. The transceiver may, in response to determining that the first STA is in a power save mode, transmit a second frame (e.g., data frame) to a second STA (e.g., STA-2) of the second wireless MLD over a second link of the plurality of links without waiting for an amount of time during which the second STA switches from a listening mode over the second link to a frame exchange mode over the second link. For example, the AP MLD may communicate with STA-2 as if STA-2 were a single radio STA without overhead of EMLSR.

In some embodiments, the transceiver may perform a frame exchange with the second wireless MLD over only one of the plurality of links at any time instance (e.g., because the second wireless MLD may include a single radio shared by the plurality of links). In some embodiments, the second wireless MLD may include a plurality of STAs each associated with a respective link of the plurality of links, the plurality of STAs including the first STA and the second STA. The transceiver may determine that each of the plurality of STAs except the second STA is in a power save mode. The transceiver may transmit a third frame (e.g., data frame) to the second STA over the second link without waiting for an amount of time (e.g., an amount of time where or during/for which the second STA switches from the listening mode over the second link to the frame exchange mode over the second link).

In some embodiments, before transmitting the first frame, the transceiver may generate a fourth frame (e.g., MU-RTS trigger frame with padding delay) including a first trigger frame and a padding portion corresponding to the first amount of time, and can transmit the first frame to the first STA. The first trigger frame may include one of a multi-user request to send (MU-RTS) frame or a buffer status report poll (BSRP) frame.

In some embodiments, after transmitting the first frame, the transceiver may receive a fifth frame (e.g., data frame whose power management (PM) bit set to 1) from the first STA after waiting for a second amount of time during which the first STA performs a transition from the listening mode over the first link to the frame exchange mode over the first link. The transceiver may determine, according to a medium access control (MAC) header of the fifth frame (e.g., PM bit of the fifth frame in the frame control filed of the MAC header), whether the first STA is in a power save mode or an active mode.

In some embodiments, in response to determining that the first STA is in a power save mode and in an awake state, the transceiver may receive a second trigger frame (e.g., PS-POLL frame) from the first STA. In response to the second trigger, the transceiver may generate a sixth frame (e.g., MU-RTS frame with padding delay) including a sixth trigger frame and a padding portion corresponding to the first amount of time, and transmit the sixth frame to the first STA. The second trigger frame may be one of a power save poll (PS-Poll) frame or an unscheduled automatic power save delivery (U-APSD) trigger frame. The sixth trigger frame may include one of a multi-user request to send (MU-RTS) frame or a buffer status report poll (BSRP) frame.

In some embodiments, the transceiver may perform, after waiting for the first amount of time, a frame exchange with the first STA. The transceiver may wait, upon completion of a frame exchange, for an amount of time during which the first STA and the second STA switch to the listening mode.

In some embodiments, in response to determining that the first STA is in the power save mode and in a doze state, the transceiver may start a first frame exchange with the second STA over the second link. Upon completion of the first frame exchange, the transceiver may start a second frame exchange with the second STA without waiting for an amount of time during which the first STA and the second STA switch to the listening mode.

Embodiments in the present disclosure have at least the following advantages and benefits. First, embodiments in the present disclosure can provide useful techniques for removing/reducing/avoiding/saving overhead incurred by an EMLSR non-AP MLD (e.g., signaling/padding/timeout or switching delay) when the non-AP MLD practically operates over only one link at a time, thereby improving the medium utilization efficiency.

Second, embodiments in the present disclosure can provide useful techniques for removing/reducing/avoiding/saving overhead incurred by an EMLSR non-AP MLD (e.g., signaling/padding/timeout or switching delay) when STAs of the non-AP MLD operate in a power save mode. In a case in which an EMLSR non-AP MLD changes or sets the power management mode to a power save mode over all the associated links except one link (“single STA link”), when an AP MLD initiates a frame exchange over the single STA link for DL transmission, the AP MLD may follow or perform a frame exchange procedure as if the non-AP MLD were a single radio STA. For example, when the AP MLD initiates a frame exchange over the single STA link for DL transmission, the AP MLD may use a single STA frame sequence (e.g., the frame sequence shown in FIG. 5) without incurring the overhead(s) of EMLSR (e.g., padding, switching delay, and/or medium synchronization recovery).

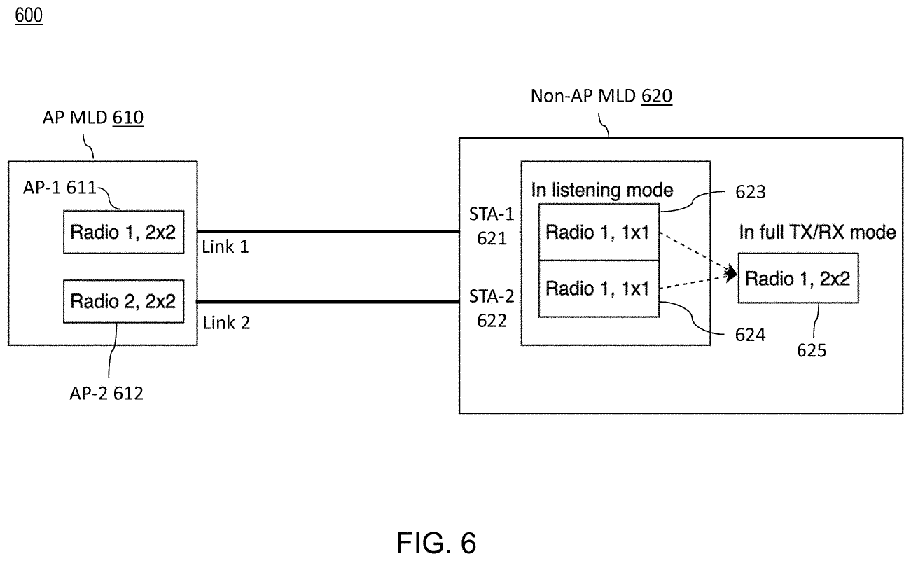

FIG. 6 illustrates an example block diagram a of a system environment 600 including one or more wireless multi-link devices (MLDs), according to an example implementation of the present disclosure. Referring to FIG. 6, an AP MLD 610 and a non-AP MLD 620 may have configurations similar to those of the AP MLD 410 and the non-AP MLD 420 as shown in FIG. 4A. The AP MLD 610 may include a first radio 611 (e.g., first radio transceiver; “radio 1” or “AP-1” in FIG. 6) and a second radio 612 (e.g., second radio transceiver; “radio 2” or “AP-2” in FIG. 6) each of which may be a 2×2 radio (e.g., 2×2 MIMO radio) configured to communicate via two streams of TX and RX over respective links (e.g., link 1 and link 2). The non-AP MLD 620 may comprise a first station STA-1 (621) and a second station STA-2 (622), which shares a single radio or an enhanced single radio (e.g., single radio transceiver; “radio 1” in FIG. 6) that operates in an EMLSR mode over a subset of links associated with the AP MLD 610. The single radio of the non-AP MLD 620 may monitor channel status (CCA) over a subset of links (e.g., link 1, link 2) in a listening mode. In the listening mode, the single radio of the non-AP MLD 620 may function as a 1×1 radio 623 (as STA-1) over link 1, or as a 1×1 radio 624 (as STA-2) over link 2. At any time instance, the single radio of the non-AP MLD 620 can participate in a frame exchange (e.g., delivering a data frame) only over one link (e.g., functioning as STA-1 over link 1 or as STA-2 over link 2) in a frame exchange mode or a full TX/RX mode. In the frame exchange mode, the single radio of the non-AP MLD 620 may function as a 2×2 radio 624 configured to communicate via two streams of TX and RX over any link of the subset of links (e.g., over link 1 or over link 2).

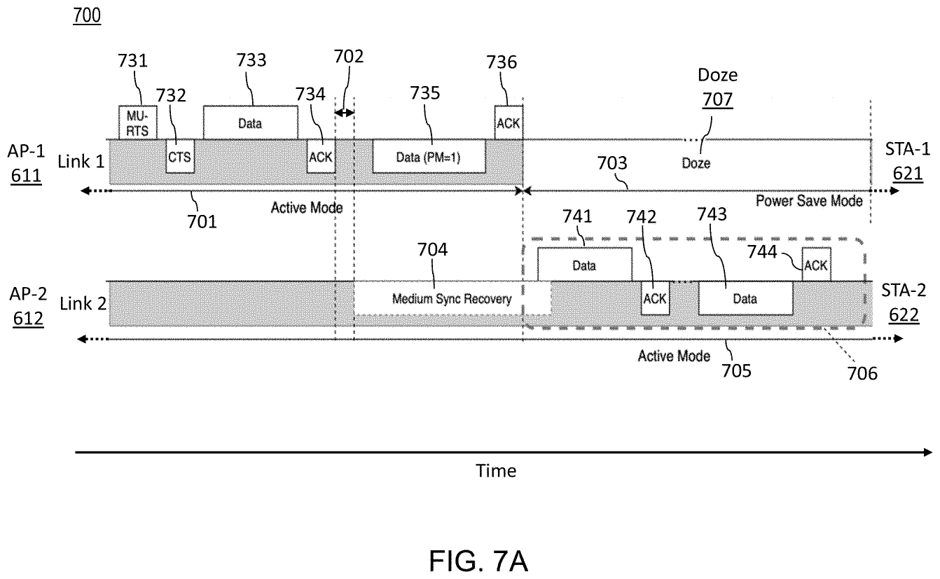

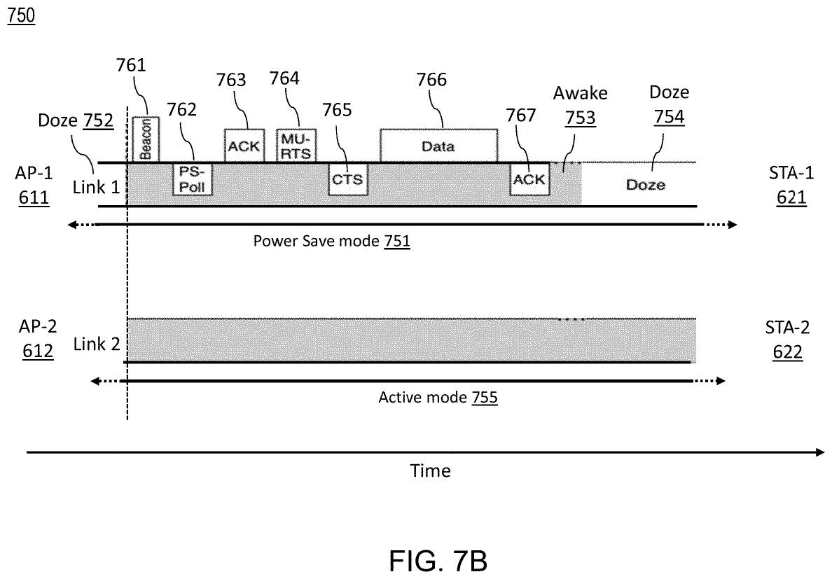

FIG. 7A and FIG. 7B illustrate example frame sequences 700 and 750 when an AP MLD (e.g., AP MLD 610) communicates with a non-AP MLD (e.g., non-AP MLD 620), according to an example implementation of the present disclosure. Referring to FIG. 7A, AP-1 611 of the AP MLD 610 and STA-1 621 of the non-AP MLD 620 may exchange a first sequence of frames for DL transmission (e.g., an MU-RTS frame 731, a CTS frame 732, a DL data frame 733, and an ACK frame 734) in a frame exchange mode and in an active mode 701, and STA-1 621 and STA-2 622 may then switch to a listening mode after waiting for an amount of time 702 corresponding to a switching delay (e.g., PIFS/RxPHYStartDelay and/or EMLSR transition delay). Before switching to the frame exchange mode, both STA-1 621 and STA-2 622 of the non-AP MLD may be in a listening mode and then configure the radio (e.g., single radio transceiver; “radio 1” in FIG. 4A) such that the radio switches to only one link (e.g., link 1) for the frame exchange. After STA-1 621 of the non-AP MLD finishes/completes the frame exchange over link 1 in the frame exchange mode, the non-AP MLD may reconfigure the radio (e.g., single radio transceiver; “radio 1” in FIG. 4A), and both STA-1 621 and STA-2 622 of the non-AP MLD switch (or switch/go back) to the listening mode. In some embodiments, the MU-RTS trigger frame 731 may have/incorporate padding (e.g., padding bits) that is sufficient/configured to cover a switching time of the single radio (e.g., STA-1 or STA-2 of non-AP MLD 620). Upon STA-1 and STA-2 switching to the listening mode, STA-2 of the non-AP MLD 620 which stays in an active mode 705 may perform a medium synchronization recovery procedure 704. STA-1 of the non-AP MLD 620 may switch from a listening mode to a frame exchange mode after waiting for an amount of time (e.g., transition delay 702) corresponding to a switching delay (e.g., PIFS/RxPHYStartDelay and/or EMLSR transition delay), and can initiate a second sequence of frames for UL transmission (e.g., an UL data frame 735, and an ACK frame 736) in the frame exchange mode and in the active mode 701. In some embodiments, STA-1 may set a power management (PM) subfield of the MAC header of the data frame 735 to 1, indicating that STA-1 is switching from the active mode 701 to a power save mode 703 (and a doze state 707). Upon determining that STA-1 is switching to the power save mode 703 (and the doze state 707), AP-2 (612) of the AP MLD 610 and STA-2 (622) of the non-AP MLD 620 may perform frame exchanges 706 in a manner similar to a single STA frame sequence as shown in FIG. 5. That is, AP-2 (612) of the AP MLD 610 may initiate a third sequence of frames for DL transmission (e.g., a data frame 741, an ACK frame 742) without waiting for a switching delay of STA-2 and/or without performing an RTS/CTS procedure that adds a padding delay. While staying in the active mode 705, STA-2 of the non-AP MLD 620 may then initiate a fourth sequence of frames for UL transmission (e.g., an UL data frame 743, and an ACK frame 744) without waiting for an amount of time corresponding to a switching delay (e.g., PIFS/RxPHYStartDelay and/or EMLSR transition delay).

Referring to FIG. 7B, while staying in the power save mode 751, STA-1 (621) of the non-AP MLD 620 may switch from a doze state 752 to an awake state 753, and can receive a beacon from AP-1 (611) of the AP MLD 610. STA-1 may then send, to AP-1 of the AP MLD, a PS-POLL trigger frame 762 which is responded with an ACK frame 763 by AP-1. AP-1 611 of the AP MLD 610 and STA-1 621 of the non-AP MLD 620 may then exchange a sequence of frames for DL transmission (e.g., an MU-RTS frame 764, a CTS frame 765, a DL data frame 766, and an ACK frame 767) in a frame exchange mode. In some embodiments, the MU-RTS trigger frame 764 may have padding (e.g., padding bits) that is sufficient to cover a switching time of the single radio (e.g., STA-1 or STA-2 of non-AP MLD 620). After completing the frame exchange sequence, STA-1 may switch from the awake state 753 to a doze state while staying in the power save mode 751. STA-2 may stay in an active mode 755 while STA-1 stays in the power save mode 751.

Referring to FIG. 6, FIG. 7A and FIG. 7B, in some embodiments, the overhead incurred by an EMLSR non-AP MLD (e.g., padding delay, switching delay or medium synchronization recovery) can be removed/reduced/avoided/saved when the non-AP MLD practically operates over only one link at a time. For example, an EMLSR non-AP MLD device (e.g., non-AP MLD 620) in communication with an AP MLD (e.g., AP MLD 610) over a plurality of links (e.g., link 1 and link 2) can change a power management mode to a power save mode in all the links associated with the AP MLD, except one link (e.g., link 2) that stays in an active mode (e.g., active mode 705, 755). In this case, only one STA of the non-AP MLD (e.g., STA-2) can be in the awake state and in the active mode, and the non-AP MLD practically operates over only one link at a time. Therefore, STA-2 can operate like a single STA device and can potentially use a frame sequence for a single STA (e.g., the frame sequence 500 in FIG. 5).

In some embodiments, the EMLSR non-AP MLD 620 may change or set the power management mode to a power save mode over all the associated links except one link (e.g., link 2). In this case, all the STAs of the non-AP MLD (e.g., STA-1) may be in the power save mode (e.g., power save mode 703, 751) in which the corresponding STA (STA-1) can be in an awake state (e.g., awake state 753) or in a doze state (e.g., doze state 707, 752, 754), except for STA-2 corresponding to link 2 can stay in the active mode (e.g., active mode 705, 755) in which the STA-2 is in an awake state, and thus the non-AP MLD practically operates over only one link at a time like a single STA. In a case in which the non-AP MLD 620 changes or sets the power management mode to a power save mode over all the associated links except link 2, when the AP MLD 610 initiates a frame exchange (e.g., frame exchange 706) over link 2 for DL transmission, the AP MLD 610 may follow or perform a frame exchange procedure as if the non-AP MLD were a single radio STA, e.g., using a single STA frame sequence (e.g., the frame sequence shown in FIG. 5) without incurring the overhead(s) of EMLSR (e.g., padding, switching delay, and/or medium synchronization recovery). In some embodiments, for link 2, the AP MLD 610 may not use a frame sequence of a trigger frame (e.g., MU-RTS or BSRP) and a corresponding response frame to proceed the DL transmission (e.g., transmission of the data frame 741). In some embodiments, for link 2, the AP MLD may use the frame sequence of a trigger frame and a corresponding response frame but may not add the padding to the trigger frame.

In some embodiments, the AP MLD 610 may operate on link 2, assuming that the EMLSR non-AP MLD 620 can perform in full TX/RX capability over link. For example, the AP MLD 610 may determine a timing of initiating a frame exchange (e.g., frame exchange 706) over link 2 without considering a switching delay between the listening mode and the full TX/RX mode over link 2, and/or without considering an amount of time for a medium synchronization recovery.

In some embodiments, STA-1 of the non-AP MLD 620 may switch to a power save mode (e.g., power save mode 703) and a doze state (e.g., doze state 707) over link 1. In some embodiments, STA-1 may send, to AP-1 of the AP MLD 610, a frame (e.g., data frame 735) with a power management (PM) subfield (or PM bit) in a MAC header of the frame (e.g., frame control field) being set to 1 for example, to indicate that STA-1 is switching to the power save mode and the doze state. After receiving an ACK frame (e.g., ACK frame 736) from AP-1, STA-1 may start the power save mode and switch into the doze state.

In some embodiments, when STA-1 of the non-AP MLD 620 switches to the power save mode 703 and the doze state 707 over the link 1, only STA-2 may remain in an active mode (e.g., active mode 705) and in an awake state over link 2. The AP MLD 610 can then perform a frame exchange with STA-2 over link 2 as a single STA frame exchange without performing an EMLSR frame exchange procedure that may incur the overhead, over link 2. In some embodiments, when STA-1 switches to an awake state (e.g., awake state 753) over link 1, upon receiving a trigger frame (e.g., PS-Poll 762), the AP MLD 610 can perform or follow the EMLSR frame exchange (e.g., frame exchange shown in FIG. 7B) over link 1.

In some embodiments, the AP MLD 610 may initiate a frame exchange for a DL transmission (e.g., transmission of data frame 766) over link 1 over which the non-AP MLD 620 is in a power save mode (e.g., power save mode 751) and in an awake state (e.g., awake state 753). When the AP MLD 610 initiates a frame exchange for a DL transmission over link 1, upon receiving a PS-Poll frame (e.g., PS-Poll 762) or a U-APSD trigger frame over link 1, the AP MLD (e.g., AP-1 of the AP MLD 610) may follow or perform an EMLSR frame exchange procedure that may incur the overhead (e.g., padding, switching delay, and/or medium synchronization recovery) over link 1.

In some embodiments, the AP MLD 610 may determine that the non-AP MLD 620 intends to (or is to) perform UL transmission over a link (“EMLSR link”) over which the non-AP MLD is in a power save mode and in an awake state. Upon determination of the non-AP MLD's intention for UL transmission over the EMLSR link, the AP MLD may follow or perform an EMLSR frame exchange procedure for the DL transmission.

In some embodiments, the AP MLD 610 may perform, after waiting for the first amount of time (e.g., padding delay), a frame exchange with STA-1 of non-AP MLD 620. The AP MLD 610 may wait, upon completion of a frame exchange (e.g., data frame 733, ACK frame 734), for an amount of time (e.g., transition delay 702) during which STA-1 and STA-2 switch to the listening mode. In some embodiments, in response to determining that STA-1 of non-AP MLD 620 is in the power save mode 751 and in the doze state 707, AP-2 of the AP MLD 610 may start a first frame exchange (e.g., data frame 741 and ACK frame 742) with STA-2 over link 2. Upon completion of the first frame exchange, the AP MLD 610 may start a second frame exchange (e.g., data frame 743 and ACK frame 744) with STA-2 without waiting for an amount of time during which STA-1 and STA-2 switch to the listening mode.

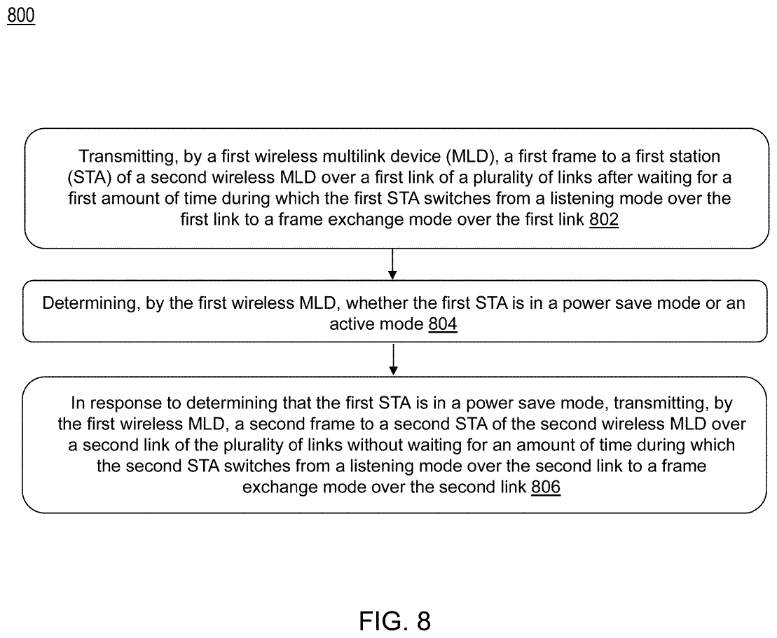

FIG. 8 is a flowchart showing a process 800 of communicating with a wireless MLD (e.g., second wireless MLD), according to an example implementation of the present disclosure. In some embodiments, the process 800 is performed by a first wireless MLD (e.g., AP MLD 610). In some embodiments, the process 800 is performed by other entities (e.g., console 110, HWD 150). In some embodiments, the process 800 includes more, fewer, or different steps than shown in FIG. 8.

In one approach, the first wireless MLD (e.g., AP MLD 610) may transmit 802 a first frame (e.g., data frame 733, 766) to a first station (STA) of a second wireless MLD (e.g., STA-1 of non-AP MLD 620) over a first link of a plurality of links (e.g., link 1) after waiting for a first amount of time (e.g., padding delay incurred by transmitting MU-RTS frame 731) during which the first STA switches from a listening mode over the first link to a frame exchange mode over the first link. In some embodiments, the first wireless MLD may perform a frame exchange with the second wireless MLD over only one of the plurality of links (e.g., link 1 or link 2) at any time instance.

In some embodiments, before transmitting the first frame (e.g., data frame 733), the first wireless MLD may generate a fourth frame (e.g., MU-RTS trigger frame 731) including a first trigger frame and a padding portion (e.g., padding bits) corresponding to the first amount of time (e.g., padding delay of several hundreds μs), and can transmit the first frame to the first STA. The first trigger frame may include one of a multi-user request to send (MU-RTS) frame or a buffer status report poll (BSRP) frame.

In one approach, the first wireless MLD (e.g., AP MLD 610) may determine 804 whether the first STA (e.g., STA-1 of non-AP MLD 620) is in a power save mode or an active mode. In some embodiments, after transmitting the first frame (e.g., data frame 733), the first wireless MLD may receive a fifth frame (e.g., UL data frame 735) from the first STA after waiting for a second amount of time (e.g., a switching delay such as PIFS/RxPHYStartDelay and/or EMLSR transition delay) during which the first STA performs a transition from the listening mode over the first link to the frame exchange mode over the first link (e.g., link 1). The first wireless MLD may determine, according to a medium access control (MAC) header of the fifth frame (e.g., power management (PM) subfield/bit of frame control field in the MAC header), whether the first STA is in a power save mode or an active mode (e.g., the first STA is in a power save mode if the PM bit equals “1”).

In one approach, in response to determining that the first STA is in a power save mode (e.g., power save mode 703), the first wireless MLD may transmit 806 a second frame (e.g., data frame 741) to a second STA of the second wireless MLD (e.g., STA-2) over a second link of the plurality of links (e.g., link 2) without waiting for an amount of time during which the second STA switches from a listening mode over the second link to a frame exchange mode over the second link.

In some embodiments, the second wireless MLD (e.g., non-AP MLD 620) may include a plurality of STAs (e.g., STA-1 and STA-2) each associated with a respective link of the plurality of links (e.g., link 1 and link 2), the plurality of STAs including the first STA (e.g., STA-1) and the second STA (e.g., STA-2). The first wireless MLD may determine that each of the plurality of STAs except the second STA is in a power save mode (e.g., STA-1 is in a power save mode 703 but STA-1 is in an active mode 705). The first wireless MLD may transmit a third frame (e.g., DL data frame 741) to the second STA (e.g., STA-2) over the second link (e.g., link 2) without waiting for an amount of time (e.g., a switching delay such as PIFS/RxPHYStartDelay and/or EMLSR transition delay) during which the second STA switches from the listening mode over the second link to the frame exchange mode over the second link.

In some embodiments, in response to determining that the first STA (e.g., STA-1) is in a power save mode (e.g., power save mode 751), the first wireless MLD (e.g., AP-1 of AP MLD 610) may receive a second trigger frame (e.g., PS-Poll frame 762) from the first STA (e.g., STA-1). It may be determined, based on a power management (PM) bit of a frame transmitted from the first STA, that the first STA is in the power save mode. The second trigger frame may indicate that the first STA is in an awake state. In response to the second trigger, the first wireless MLD may generate a sixth frame (e.g., MU-RTS frame 764) including a sixth trigger frame and a padding portion (e.g., padding bits) corresponding to the first amount of time (e.g., padding delay to be incurred by transmission of MU-RTS frame 764), and can transmit the sixth frame to the first STA. The second trigger frame may be one of a power save poll (PS-Poll) frame or an unscheduled automatic power save delivery (U-APSD) trigger frame. The sixth trigger frame may include one of a multi-user request to send (MU-RTS) frame or a buffer status report poll (BSRP) frame.

In some embodiments, in response to determining that the first STA (e.g., STA-1 of non-AP MLD 620) is in a power save mode (e.g., power save mode 751) and in an awake state (e.g., awake state 753), the first wireless MLD (e.g., AP-1 of AP MLD 610) may start a frame exchange with the first STA after waiting for a third amount of time during which the first STA performs a medium synchronization recovery on the first link. In some embodiments, in response to determining that the first STA (e.g., STA-1 of non-AP MLD 620) is in the power save mode (e.g., power save mode 751), the first wireless MLD may start a frame exchange with the second STA (e.g., STA-2 of non-AP MLD 620) over the second link (e.g., link 2) without waiting for an amount of time during/for which the second STA performs a medium synchronization recovery on the second link.

In some embodiments, the first wireless MLD may perform, after waiting for the first amount of time, a frame exchange with the first STA (e.g., STA-1 of non-AP MLD 620). The first wireless MLD may wait, upon completion of a frame exchange (e.g., data frame 733, ACK frame 734), for an amount of time (e.g., transition delay 702) during which the first STA and the second STA switch to the listening mode.

In some embodiments, in response to determining that the first STA (e.g., STA-1 of non-AP MLD 620) is in a power save mode (e.g., power save mode 751) and in a doze state (e.g., doze state 707), the first wireless MLD may start a first frame exchange (e.g., data frame 741 and ACK frame 742) with the second STA over the second link. Upon completion of the first frame exchange, the first wireless MLD may start a second frame exchange (e.g., data frame 743 and ACK frame 744) with the second STA without waiting for an amount of time during which the first STA and the second STA switch to the listening mode.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A first wireless multi-link device (MLD) comprising a transceiver configured to:
transmit a first frame to a first station (STA) of a second wireless MLD over a first link of a plurality of links after waiting for a first amount of time during which the first STA switches from a listening mode over the first link to a frame exchange mode over the first link;
determine whether the first STA is in a power save mode or an active mode; and
in response to determining that the first STA is in a power save mode, transmit a second frame to a second STA of the second wireless MLD over a second link of the plurality of links without waiting for an amount of time during which the second STA switches from a listening mode over the second link to a frame exchange mode over the second link.

2. The first wireless MLD of claim 1, wherein the transceiver is configured to perform frame exchange with the second wireless MLD over only one of the plurality of links at any time instance.

3. The first wireless MLD of claim 1, wherein:
the second wireless MLD comprises a plurality of STAs each associated with a respective link of the plurality of links, the plurality of STAs including the first STA and the second STA, and
the transceiver is configured to:
determine that each of the plurality of STAs except the second STA is in a power save mode; and
transmit a third frame to the second STA over the second link without waiting for an amount of time during which the second STA switches from the listening mode over the second link to the frame exchange mode over the second link.

4. The first wireless MLD of claim 1, wherein the transceiver is configured to:
before transmitting the first frame, generate a fourth frame including a first trigger frame and a padding portion corresponding to the first amount of time, and transmit the first frame to the first STA.

5. The first wireless MLD of claim 4, wherein the first trigger frame includes one of a multi-user request to send (MU-RTS) frame or a buffer status report poll (BSRP) frame.

6. The first wireless MLD of claim 1, wherein the transceiver is configured to:
after transmitting the first frame, receive a fifth frame from the first STA after waiting for a second amount of time during which the first STA performs a transition from the listening mode over the first link to the frame exchange mode over the first link; and
determine, according to a medium access control (MAC) header of the fifth frame, whether the first STA is in a power save mode or an active mode.

7. The first wireless MLD of claim 1, wherein in response to determining that the first STA is in a power save mode, the transceiver is configured to:
receive a second trigger frame from the first STA; and
in response to the second trigger, generate a sixth frame including a sixth trigger frame and a padding portion corresponding to the first amount of time, and transmit the sixth frame to the first STA.

8. The first wireless MLD of claim 7, wherein:
the second trigger frame is one of a power save poll (PS-Poll) frame or an unscheduled automatic power save delivery (U-APSD) trigger frame, and
the sixth trigger frame includes one of a multi-user request to send (MU-RTS) frame or a buffer status report poll (BSRP) frame.

9. The first wireless MLD of claim 1, wherein the transceiver is configured to:
perform, after waiting for the first amount of time, a frame exchange with the first STA, and
wait, upon completion of a frame exchange, for an amount of time during which the first STA and the second STA switch to the listening mode.

10. The first wireless MLD of claim 1, wherein the transceiver is configured to:
in response to determining that the first STA is in the power save mode and in a doze state, start a first frame exchange with the second STA over the second link, and
upon completion of the first frame exchange, start a second frame exchange with the second STA without waiting for an amount of time during which the first STA and the second STA switch to the listening mode.

11. A method comprising:
transmitting, by a first wireless multi-link device (MLD), a first frame to a first station (STA) of a second wireless MLD over a first link of a plurality of links after waiting for a first amount of time during which the first STA switches from a listening mode over the first link to a frame exchange mode over the first link;
determining, by the first wireless MLD, whether the first STA is in a power save mode or an active mode; and
in response to determining that the first STA is in a power save mode, transmitting, by the first wireless MLD, a second frame to a second STA of the second wireless MLD over a second link of the plurality of links without waiting for an amount of time during which the second STA switches from a listening mode over the second link to a frame exchange mode over the second link.

12. The method of claim 11, wherein the first wireless MLD performs frame exchange with the second wireless MLD over only one of the plurality of links at any time instance.

13. The method of claim 11, wherein
the second wireless MLD comprises a plurality of STAs each associated with a respective link of the plurality of links, the plurality of STAs including the first STA and the second STA, and
the method further comprises:
determining that each of the plurality of STAs except the second STA is in a power save mode; and
transmitting a third frame to the second STA over the second link without waiting for an amount of time during which the second STA switches from the listening mode over the second link to the frame exchange mode over the second link.

14. The method of claim 11, further comprising:
before transmitting the first frame, generating a fourth frame including a first trigger frame and a padding portion corresponding to the first amount of time, and transmitting the first frame to the first STA.

15. The method of claim 14, wherein the first trigger frame includes one of a multi-user request to send (MU-RTS) frame or a buffer status report poll (BSRP) frame.

16. The method of claim 11, further comprising:
after transmitting the first frame, receiving a fifth frame from the first STA after waiting for a second amount of time during which the first STA performs a transition from the listening mode over the first link to the frame exchange mode over the first link; and
determining, according to a medium access control (MAC) header of the fifth frame, whether the first STA is in a power save mode or an active mode.

17. The method of claim 11, further comprising:
in response to determining that the first STA is in a power save mode and in an awake state:
receiving a second trigger frame from the first STA; and
in response to the second trigger, generating a sixth frame including a sixth trigger frame and a padding portion corresponding to the first amount of time, and transmitting the sixth frame to the first STA.

18. The method of claim 17, wherein
the second trigger frame is one of a power save poll (PS-Poll) frame or an unscheduled automatic power save delivery (U-APSD) trigger frame, and
the sixth trigger frame includes one of a multi-user request to send (MU-RTS) frame or a buffer status report poll (BSRP) frame.

19. The method of claim 11, further comprising:
performing, after waiting for the first amount of time, a frame exchange with the first STA, and
waiting, upon completion of a frame exchange, for an amount of time during which the first STA and the second STA switch to the listening mode.

20. The method of claim 11, further comprising:
in response to determining that the first STA is in the power save mode and in a doze state, starting a first frame exchange with the second STA over the second link, and
upon completion of the first frame exchange, starting a second frame exchange with the second STA without waiting for an amount of time during which the first STA and the second STA switch to the listening mode.
